(19) United States
(12) Patent Application Publication
(10) Pub. No.: US 2016/0167128 A1
(43) Pub. Date: Jun. 16, 2016

(54) CLEANING DEVICE

(71) Applicant: BÜHLER AG, Uzwil (CH)

(72) Inventor: Claude STALDER, Gossau (CH)

(21) Appl. No.: 14/908,732

(22) PCT Filed: Jun. 17, 2014
(86) PCT No.: PCT/EP2014/062721

§ 371 Date: Jan. 29, 2016

(30) Foreign Application Priority Data
Jul. 31, 2013 (EP) 13178708.7

(51) Int. Cl. B22D 45/00; B01D 45/16; B01D 50/00; B22D 17/14

(52) U.S. Cl. CPC B22D 45/005; B22D 17/145; B01D 45/16; B01D 50/002

(57) ABSTRACT

A cleaning device (1), for a die casting device, comprising: a housing (2) having an inlet (3) for medium to be cleaned; a cyclone (4) arranged in the housing (2) downstream of the inlet (3); a unit (5), which is arranged on the housing (2), projects into the cyclone (4), and has at least one opening (8) at the lower end of the unit, preferably in the base face of the unit. A medium to be cleaned enters the unit (5) through the opening (6); a filter insert (7) is arranged in the unit (5); and an outlet (8) is arranged downstream of the filter insert (7). A device for producing cast parts and a method for producing cast parts, preferably from metal or metallic alloys, with such a device using vacuum casting, and to the use of the cleaning unit and of the die casting device in such method.

The present invention relates to a cleaning device which may be employed in particular in vacuum casting using die-casting machines.

In order for castings to be manufactured, respective casting material may be introduced into a casting mold having contours which correspond to the shape of the casting and left there to solidify. Die-casting machines are suitable for manufacturing metallic castings such as engine blocks, for example. A die-casting machine comprises a casting mold which is composed of at least two mold halves (one a fixed and one a movable mold half) which together form a void (also referred to as the cavity or the shaped contour) which corresponds to the component to be manufactured. A melt of the material to be molded, for example aluminum, is forced into this void at high velocity and pressure with the aid of a casting piston. After the metal melt has solidified in the void, the mold is opened by moving the movable mold halves, and the finished cast component is ejected with the aid of ejectors.

A horizontal dual-plate die-casting machine is described in an exemplary manner in, WO 2008/131571 A1. This dual-plate die-casting machine comprises a movable plate (BAP) and a fixed plate (PAP), in each case one casting-mold half being disposed thereon. The die-casting mold may be opened and closed by moving the movable plate. In the closed position the two plates are tightly pressed together, such that the two casting-mold halves form one closed mold. A metallic melt is introduced under pressure into the closed mold and cooled while solidifying. The solidified casting may be removed after the mold has been opened (by moving the movable plate).

Particular requirements are set for thin-walled to medium-walled structural components for the automotive industry. These components have to have inter alia good weldability, high mechanical stressability, and a low rate of variation caused by production. In the case of a conventional die-casting method there is the risk of air or gas inclusions in the melt even with good ventilation, this potentially leading to undesirable porosity in the casting. Therefore, the casting may under certain circumstances no longer reliably meet the specific high requirements set for the automotive industry.

As an alternative, certain castings, for example for the automotive industry, are therefore manufactured in a vacuum die-casting method. Here, the gaseous atmosphere which is present in the casting mold is at least partially removed, preferably as completely as possible. The vacuum die-casting method has proven to be the preferred manufacturing method in particular for castings which have to undergo subsequent heat treatment.

In order for the vacuum die-casting method to be carried out it is necessary for the die-casting machine to be provided with powerful vacuum equipment (in particular a powerful vacuum pump and good vacuum regulation), and the molding and casting gear to be able to be well sealed in relation to the environment.

In order for a vacuum die-casting method to be carried out, a flow duct which leads from the void (also referred to as the cavity or the shaped contour), which corresponds to the component to be manufactured, into a gas line which is connected to a vacuum pump. This fluidic connection between the void and the vacuum pump may be opened and closed with the aid of a closing device, preferably a valve. The vacuum die-casting method is known to a person skilled in the art.

One problem in the case of the vacuum die-casting method lies in that during removal of the gaseous atmosphere from the void of the mold also part of the casting material which is located in the void, or in the casting chamber which is connected to the void, respectively, as well as residue of lubricants and mold release agents are conjointly drawn and make their way into the vacuum pump, or may lead to constrictions and in the worst case to clogging in the vacuum lines and vacuum valves. This ultimately leads to destruction of the vacuum pump.

Therefore, a filter has already been installed in the flow duct which connects the void of the mold to the vacuum pump of vacuum die-casting machines which are already in the market. However, it has been demonstrated that the proportion of casting material which is conjointly drawn with the gaseous atmosphere from the void is so high that a conventional filter very rapidly is clogged and has to be replaced in a correspondingly frequent manner. Undesirably frequent operational stoppages thus arise.

It is the object of the present invention to provide a cleaning unit by way of which a gaseous atmosphere, in particular from, the void of the mold of a die-casting machine, may be cleaned in an efficient manner without frequent maintenance-related operational stoppages arising herein. It is moreover the object of the present invention to provide a device for manufacturing castings, preferably a die-casting device, which may be efficiently operated in particular in a vacuum die-casting method, without frequent maintenance-related operations stoppages.

The present object is achieved by a cleaning device, in particular for a die-casting device, comprising
a housing having an inlet for a medium to be cleaned,
a centrifugal separator which is disposed downstream of the inlet in the housing,
a unit which is disposed on the housing and protrudes into the centrifugal separator and at the lower end thereof preferably in the base area thereof, has at least one opening, wherein the medium to be cleaned may enter into the unit through this at least one opening,
a filter insert which is disposed in the unit, and
an outlet which is disposed downstream of the filter insert.

The cleaning device according to the invention is based on a combination of a centrifugal separator and a conventional filter element. A substantial part of the casting material which is conjointly drawn with the gas is already removed in the centrifugal separator. Only additional removal of residual material is thus performed in the conventional filter element. The conventional filter element is thus stressed to a lesser degree and does not clog as fast. Therefore, the plant in which the cleaning device according to the invention is installed needs to be stopped less frequently for maintenance-related reasons.

A combination of a centrifugal separator (also referred to as a tangential separator) and a conventional filter element has been proposed in a dissimilar arrangement for other applications in the prior art.

A combination of centrifugal separation and a conventional filter element for cleaning metallic casting material for sand casting prior to the latter entering into the mold is described in EP-2 361 223 B1.

It is essential here that the metallic casting material is guided into the centrifugal separator in such a manner that said metallic casting material initially is in contact with the conventional filter element prior to being guided through the centrifugal separator and exiting into the casting mold via the filter element.

In DE 198 05 205 A1 the gaseous atmosphere is suctioned from above a cooled and continuously cast element and then sequentially guided though mutually separated centrifugal separator elements, heating elements, and filter elements.

A separator system for removing particles, in particular soot particles, from process gases of chemical or petrochemical plants is described in EP-0 580 005 B1. In a first stage, the particles are removed in a centrifugal, separator. In a second stage, the pre-cleaned process gas reaches a filter element. As an essential element, this separator system has means for thermal regeneration of the filter element which by way of flame cleaning the residual soot particles render the filter element fit for renewed loading. The construction of the separator system is not described in more detail.

A cleaning device for a vacuum cleaner, in which the suctioned air is initially guided through a tangential separator, subsequently at the upper end of the tangential separator makes its way into an axial cyclone separator and flows through the latter from top to bottom prior to the air being guided out of the vacuum cleaner via a filter element is described in DE 10 2006 046 328 A1.

In these documents the compact cleaning device of the present invention, in which centrifugal separation and conventional filtration are performed efficiently in a comparatively small and single component, is not described. In particular, none of the documents discussed above describes the potential for a cleaning unit of this type to be efficiently employed in a vacuum die-casting method, or in a die-casting machine, respectively, that is to say that a cleaning device of this type may be employed in the conditions of the die-casting method (in which the gaseous atmosphere to be cleaned and the particles to be removed have a high temperature), without frequent maintenance-related operational stoppages arising (that is to say that the cleaning device is distinguished by high tolerance in relation to contamination).

The cleaning device according to the invention is distinguished by a compact construction principle. Said cleaning device according to the invention as substantial components comprises a centrifugal separator which is disposed in a housing, and a filter element which is disposed in an element protruding into the centrifugal separator.

The housing of the cleaning unit according to the invention may have any desired external shape. A cylindrical external shape is preferable, since the interior of the housing then already displays the cylindrical shape which is required for a tangential separator.

An inlet for the medium to be cleaned, preferably for a gaseous atmosphere emanating from the void of a casting mold, opens into the housing. The inlet is preferably disposed in the upper third of the housing, so that the gaseous atmosphere perfuses the tangential separator across a height which is sufficient for separation. Devices for a preferably hermetic connection between the cleaning device and components of a plant are preferably disposed at the inlet.

“Hermetic” according to the invention here is to be understood that the connection between the cleaning device and the component of the plant is gas-tight such that the desired vacuum which has been established can be maintained.

According to the invention, “vacuum” is understood to be a pressure which in relation to the atmospheric pressure has been reduced, preferably a pressure in the range of 20 mbar to 200 mbar.

“Upstream” and “downstream” according to the invention are understood to be positions which in the flow direction of the medium to be cleaned are ahead or behind a specific position.

A “fluidic connection” according to the invention is understood to mean that fluid, such as the medium to be cleaned, preferably gas, can move between two points, that is to say can make its way from one point to the other point.

According to the invention, the inlet of the cleaning device is preferably connected to the flow duct which comes out of the void of the casting mold of a die-casting machine. The connection here is preferably performed by way of a quick-action closure (for example a quick-action closure DN 40 ISO-Kf).

A centrifugal separator (tangential separator) is disposed in the housing. Devices in which at least one part is separated from a mixture by exploiting centrifugal force are referred to as a centrifugal separators. To this end, the mixture is in fed through an inlet, set in rotation, and subsequently the residue which has been relieved of the separated part is removed via an outlet. Centrifugal separators are well known to a person skilled in the art.

In the case of the cleaning device according to the invention, a separate tangential separator may be disposed in the housing, for example when the housing does not have a cylindrical shape. However, the tangential separator is preferably formed by the cylindrical internal wall of the housing and by that part of the unit comprising the filter insert that protrudes into the housing. The part of the unit comprising the filter insert that protrudes into the housing and in the case of this embodiment thus into the tangential separator is preferably a cylindrical pipe. This part, preferably the pipe, forms the inner delimitation of the space in which the medium to be cleaned may flow through the tangential separator.

The medium to be cleaned, preferably a gaseous atmosphere emanating from the void of a casting mold or from a casting chamber, makes its way through the inlet of the cleaning device according to the invention into the interior of the housing and thus into the tangential separator. According to the preferred embodiment previously described, the medium to be cleaned may flow through the space which is formed by the internal wall of the housing and by the external wall of that part of the unit comprising the filter insert that protrudes into the housing. The housing is closed at the top, such that the medium to be cleaned which enters through the inlet which is preferably disposed in the upper third of the housing flows through the previously described space downward through the tangential separator. According to the invention it is to be guaranteed here that the space which is perfused by the medium to be cleaned is of adequate size such that effective and centrifugal-force based separation of particles from the medium is achieved during perfusion of the medium. That part of the unit comprising the filter insert that protrudes into the housing by this required length correspondingly protrudes into the housing and thus into the tangential separator. Depending on the desired application, the exact dimensions may be readily determined by a person skilled in the art.

The housing and the unit comprising the filter insert are preferably configured so as to be integral, but are in any case interconnected such that no medium may leak between the housing and the unit. The unit is located on the cover face of the housing, part of the unit protruding though the cover face into the housing, as has been described. According to one preferred embodiment of the present invention at least those surfaces of the housing and unit that come into contact with the medium to be cleaned are designed in such a manner that they are not corroded by the medium to be cleaned. Since the medium to be cleaned in the preferred embodiment of the use of the cleaning unit according to the invention in a vacuum die-casting method may have a high temperature and may contain metallic particles or droplets, the respective surfaces of the housing and of the unit are preferably made from stainless steel.

At a suitable height, that part of the unit, comprising the filter insert that protrudes into the housing has at least one opening by way of which the medium may be transferred from the tangential separator into this unit. This at least one opening is preferably located in the lower third of that part of the unit comprising the filter insert that, protrudes into the housing. This opening is preferably located in the base area of the part, and particularly preferably the part, in particular a pipe, has an open base area.

According to one preferred embodiment of the present invention, the medium to be cleaned flows through the tangential separator up to the at least one opening in that part of the unit comprising the filter insert that protrudes into the housing, preferably up to the open base area of a pipe, and there is transferred from the tangential separator into the interior of this unit. The medium flows through that part of the unit comprising the filter insert that protrudes into the housing upward and here passes through the filter insert which is disposed in the unit, on account of which said medium is subject to further cleaning.

The material which in the tangential separator has been separated by the centrifugal force from the medium, for example metallic particles, by way of the effect of gravity falls onto the base of the housing. According to one preferred embodiment of the present invention, the housing is designed such that it has a closable opening, preferably in the form of a base part which is at least partially separable from the housing, for removing deposits. The housing may be opened in the case of maintenance, and the material which has been separated in the tangential separator may be removed. According to one preferred embodiment of the present invention, the housing has a base part which comprises the lower tenth of the housing, for example, and which is fastened to the housing with the aid of a hermetic connection, preferably of a quick-action closure. The hermetic connection may be opened in the case of maintenance, and the base part may be swung down or be completely removed from the housing, respectively.

The filter insert used in the cleaning device according to the invention may have a defined or non-defined mesh size. Conventional filter inserts which withstand the operating conditions, for example the high temperatures prevailing in the preferred embodiment of the use of the cleaning unit according to the invention in a vacuum die-casting method and the attendant metallic particles, may be used. Ceramic filters may be cited in an exemplary manner. However, according to the invention non-corroding steel wool (stainless-steel wool) is preferably employed as the filter medium. According to one preferred embodiment of the present invention, the filter insert is constructed from two plates in the unit, said plates being provided with openings, and from a filter medium, preferably stainless-steel wool, which is disposed between the plates. The plates here have sufficiently large and/or numerous openings for the medium to be cleaned to be able to flow through the filter insert without any significant pressure loss. According to one further embodiment, the filter insert may be composed of a prefabricated filter cartridge which has base and cover faces which are configured according to the previously described plates and contains in the interior the filter medium (for example stainless-steel wool).

According to one preferred embodiment of the present invention, the unit comprising the filter insert is designed in such a manner that said unit is configured so as to be integral with the housing; a part, preferably a pipe, protrudes into the housing, as has previously been described; and another portion of the unit is located outside the housing. The filter insert is preferably located in this portion outside the housing. That part that protrudes into the housing is particularly preferably a pipe which by way of one end is connected to the tangential separator which is disposed in the housing, and by way of the other end opens into the portion in which the filter insert is disposed.

The outlet from which the cleaned-out medium exits the cleaning device according to the invention is also located in that portion of the unit that has been previously described. Particularly preferably, the outlet is laterally disposed on the portion. On account thereof, it is possible for this portion of the unit to be provided with a closable opening, preferably in the form of an at least partially removable lid. This portion of the unit may be opened in the case of maintenance, and the filter insert which is disposed in the portion may be worked on or be removed and replaced, for example. According to one preferred embodiment of the present invention, the portion has a lid which is fastened to the portion with the aid of a hermetic connection, preferably a quick-action closure. The hermetic connection may be opened in the case of maintenance, and the lid may be swung open or be completely removed from the portion, respectively.

Devices for a preferably hermetic connection between the cleaning device and components of a plant are preferably disposed on the outlet. According to the invention, the outlet of the cleaning device is preferably connected to a pump, preferably a vacuum pump, or to a line which leads to a pump, preferably to a vacuum pump. The connection here is preferably performed by way of a quick-action closure (for example, a quick action-closure DN 40 ISO-KF).

According to one further preferred embodiment, the cleaning device according to the invention on the unit containing the filter insert comprises a device for measuring a pressure loss on the filter insert. This pressure measurement device may be designed such, for example, that it comprises a pipe which opens into the unit upstream of the filter insert, a pipe which opens into the unit downstream, of the filter unit and a pressure measuring unit connected to the pipes. The pressure differential between a position upstream of the filter insert and of a position downstream of the filter insert may thus be determined in a known manner. An intense pressure loss is an indicator of clogging of the filter insert and thus of potentially required maintenance on the cleaning device by way of cleaning or replacing the filter insert. Pressure measuring units are known to a person skilled in the art.

The previously described cleaning device is particularly suitable for use in a device for manufacturing castings, preferably in a die-casting device. The cleaning device according to the invention is particularly suitable for use in a vacuum die-casting method.

The present invention thus also relates to a device for manufacturing castings, preferably to a die-casting device, comprising a cleaning device according to the invention.

Die-casting machines for conventional die-casting methods and vacuum die-casting machines are well known to a person skilled in the art and need not be described in detail here. According to the invention, cold-chamber die-casting machines are preferable.

In order for a vacuum die-casting method to be carried out, a flow duct in the casting mold is provided, which leads from the void (also referred to as the cavity or the shaped contour) which corresponds to the component to be manufactured into a gas line and to which a pump, preferably a vacuum pump, is connected. The fluidic connection between the void and the pump, preferably the vacuum pump, may be opened and closed with the aid of a closing device, preferably a valve. The cleaning device according to the invention may be introduced into the flow path at a desired or suitable position in the connection line between the closing device and the pump, preferably the vacuum pump, in that the inlet of the cleaning device as previously described is connected to the line coming out of the flow duct from the mold, and the outlet of the cleaning device as previously described is connected to the pump, preferably the vacuum pump, or to a line leading to a pump, preferably a vacuum pump.

According to one further embodiment of the present invention, the cleaning device according to the invention may be connected directly to the casting chamber of a die-casting machine. On account thereof, efficient cleaning of the gaseous atmosphere attendant in the casting chamber and a more rapid execution of the evacuation procedure is achieved. Connecting the cleaning device according to the invention to the casting chamber may be performed in a conventional manner, for example by way of a line of which the one end is connected to an outlet of the casting chamber and the other end is connected to the inlet of the cleaning device. In the case of this embodiment, the outlet of the cleaning device as previously described is connected to the pump, preferably the vacuum pump, or to a line leading to a pump, preferably a vacuum pump. A closing device, such as a valve, is disposed in the connection between the casting chamber and the cleaning device.

In the case of this embodiment the pump may optionally and additionally be connected to the previously described line coming out of the flow duct from the mold. As has been previously described, the cleaning device according to the invention may be introduced into the flow path coming out of the void of the mold in that the inlet of the cleaning device as previously described is connected to the line coming from the flow duct out of the mold, and the outlet of the cleaning device as previously described is connected to the pump, preferably the vacuum pump, or to a line leading to a pump, preferably a vacuum pump. However, according to one further variant, it suffices in this embodiment for a standard filter element to be inserted into this flow path coming out of the void of the mold, since cleaning of the gaseous atmosphere of the casting chamber in this embodiment is mainly performed by way of the cleaning device according to the invention, which is connected to the casting chamber.

The present invention furthermore relates to a method for manufacturing castings, preferably from metal or metallic alloys, with a device as previously described for manufacturing castings, preferably a die-casting device, the method comprising the steps of:
hermetically closing the void of a casting mold in relation to the environment,
at least partially removing the gaseous atmosphere from the casting chamber and from the void of the casting mold, and
filling casting material into the void of the casting mold,
   wherein the gaseous atmosphere removed from the casting chamber and/or from the void is directed through a cleaning unit.

In the case of a cold-chamber die-casting machine the molten casting material is guided via a filling opening into a casting chamber and is forced under pressure from the casting chamber into the void of the casting mold by way of movement of a casting piston. The casting chamber is disposed so as to be horizontal in relation to the casting mold.

If and when the casting piston is moved forward in the casting chamber, that is so say in the direction toward the casting mold, said casting piston as from a certain point in time reaches a position between the filling opening and the casting mold, interrupting the fluidic connection between the filling opening of the casting chamber and the void of the casting mold. The void of the casting mold and the piston chamber of the casting chamber, which is in fluidic connection with the void of the casting mold, are now hermetically sealed in relation to the environment.

How the closing device, preferably a valve, leading out of the casting mold or out of the casting chamber is opened and the gaseous atmosphere in the void of the casting mold and in the piston chamber of the casting chamber, which is in fluidic connection with the casting mold, is removed from these spaces with the aid of a pump, preferably a vacuum pump. In the vacuum die-casting method, negative pressure in the range from 50 mbar to 200 mbar, preferably from 100 mbar to 150 mbar is usually generated in the casting mold in this method step. Since the casting material located in the casting chamber has melted, the former may easily be conjointly drawn along with the gas. The gas and the casting material which potentially has been conjointly drawn is therefore guided through the cleaning device according to the invention, thus preventing casting material making its way into the pump.

Once the desired negative pressure has been attained in the casting mold, the casting material is forced under pressure into the void of the casting mold in a known manner by movement of the casting cylinder. The closing device leading out of the casting mold, preferably a valve, is closed preferably in the last possible moment of filling of the casting mold. In this way, maximum evacuation of the gas from the casting mold is achieved. This is typically followed by a post-pressure phase and a cooling phase. The finished casting is subsequently removed from the mold in that the two mold halves are separated.

The die-casting method in the case of commercially available die-casting machines, such as the die-casting machine CARAT® by the Bühler company, is computer controlled. This is known to a person skilled in the art and need not be elaborated any further at this point.

According to one preferred embodiment of the present invention, the pressure at the filter insert of the cleaning device is checked during the die-casting method, preferably using the previously described pressure measuring device. If a significant pressure loss at the filter insert is observed, the process sequence should be interrupted and the filter insert should be worked on or replaced, so as to prevent clogging of the cleaning unit and thus a loss of vacuum in the casting mold.

The present invention also relates to the use of a device as previously described, preferably of a die-casting device, for manufacturing castings, preferably from metal or metallic alloys, preferably in a vacuum casting process.

The present invention will be discussed in more detail hereunder by means of preferred embodiments and by drawings in which:

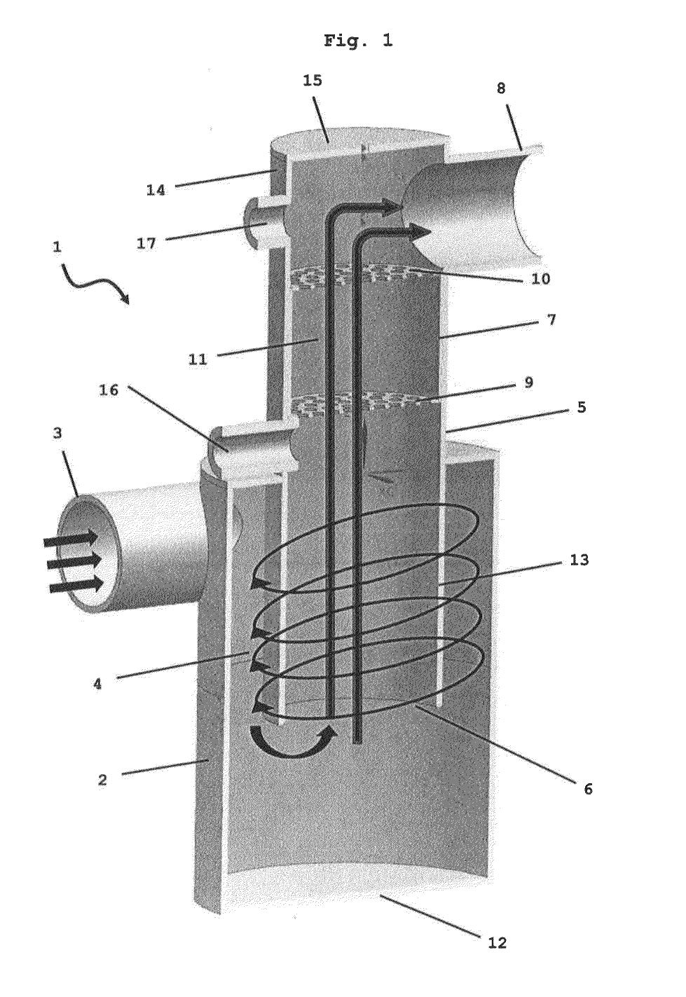

FIG. 1 shows a schematic view of an embodiment of the cleaning device according to the invention;

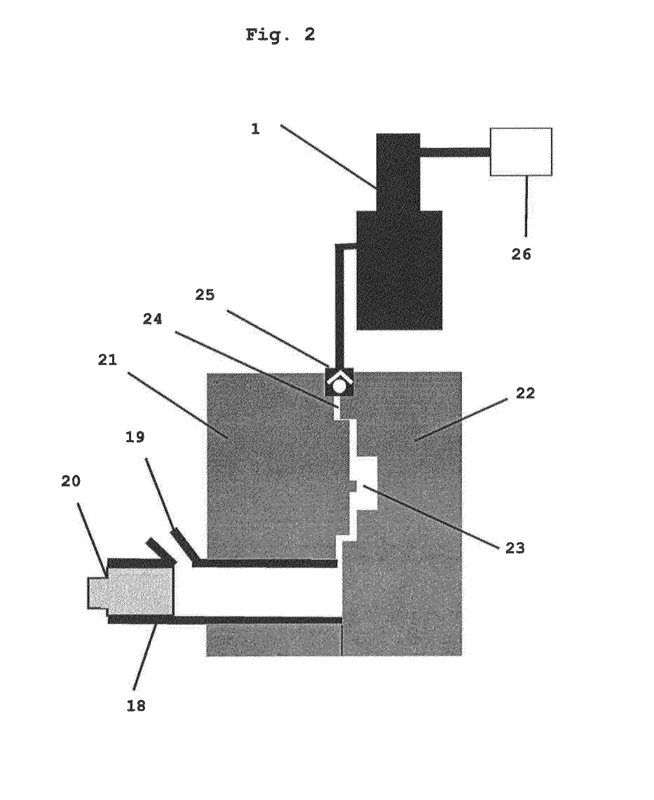

FIG. 2 shows a schematic view of an embodiment of the die-casting device according to the invention; and

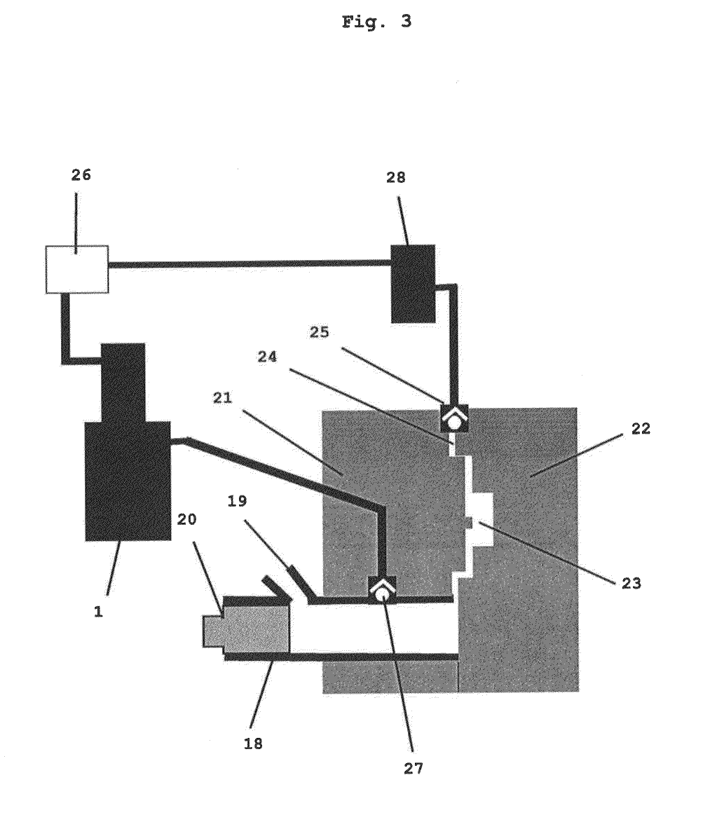

FIG. 3 shows a schematic view of a further embodiment of the die-casting device according to the invention.

A schematic view of an embodiment of the cleaning device 1 according to the invention, in particular for a die-casting device, is shown in FIG. 1. This cleaning device 1 comprises a housing 2 having an inlet 3 for a medium to be cleaned, said inlet 3 here being located in the upper third of the housing 2. A centrifugal separator 4, the outer delimitation of which is formed by the cylindrical internal wall of the housing 2, is disposed downstream of the inlet 3 in the housing 2. A unit 5 is disposed on the housing 2. In this embodiment, the unit 5 is configured so as to be integral with the housing 2. The unit 5 by way of one part protrudes through the cover face of the housing 2 into the housing, here more specifically into the centrifugal separator 4 which is disposed in the housing 2. That part of the unit 5 that protrudes into the housing 2 here is configured, as a pipe 13. The external wall of the pipe 13 thus forms the inner delimitation of the centrifugal separator 4. An opening 6 is present at the lower end of the pipe 13. According to the embodiment shown here, the entire base area of the pipe 13 is open, that is to say the opening 6 is formed thereby.

The medium to be cleaned enters into the centrifugal separator 4 through the inlet 3 and, as is shown in FIG. 1, is moved downward through the centrifugal separator 4 in a circular manner. Here, material which is present in the medium is separated by the effect of the centrifugal force, moved to the internal wall of the housing 2, and on account of the effect of gravity finally sinks onto a base part 12. This base part 12 may (not illustrated here) at least partially be separated from the housing 2, so as to remove deposits from the housing 2.

As is shown in FIG. 1, the medium to be cleaned is guided out of the centrifugal separator 6 through the opening 6 into the pipe 13. As is shown in FIG. 1, the medium travels through the pipe 13 upward to a filter insert 7 which is disposed in the unit 5. In the embodiment according to FIG. 1 the filter insert is constructed from two plates 9, 10 in the unit 5, said plates 9, 10 being provided with openings, and from a filter medium 11, preferably stainless-steel wool, which is disposed between the plates.

After perfusion of the filter insert 7, the medium exits the cleaning device 1 through an outlet 3 which is disposed downstream of the filter insert 1, as is shown in FIG. 1.

Outside the housing 2, the pipe 13 of the unit 5 opens into a portion 14 of the unit 5, in which the filter insert 7 is located and on which the outlet 8 is preferably laterally disposed, as is shown in FIG. 1. The portion 14 of the unit 5 in the embodiment according to FIG. 1 has a closable opening 15, here in the form of an at least partially removable lid.

A device (not completely shown) for measuring a pressure loss in the filter insert 7 is disposed on the unit 5 in the case of the embodiment according to FIG. 1. In the embodiment shown here, the pressure measuring device comprises a pipe 16 which opens into the unit 5 upstream of the filter insert 7 and a pipe 17 which opens into the unit 5 downstream of the filter insert 7, and a pressure measuring unit (not shown) which is connected to the pipes 16, 17.

Devices (not shown) for a preferably hermetic connection between the cleaning device 1 and components of a plant are disposed at the inlet 3 and at the outlet 8.

FIG. 2 shows a schematic view of an embodiment of the die-casting device according to the invention. The cold-chamber die-casting device shown in FIG. 2 comprises a horizontally disposed casting chamber 18 which has a casting piston 20, which is movable in the casting chamber 18, and a filling opening 19 for filling the casting material into the casting chamber 18.

The casting mold is formed by two mold halves 21 and 22 which in the closed position together form a void 23 which constitutes the actual cavity for manufacturing a casting. The void 23 is connected to the cleaning device 1 via a flow duct 24. This connection may be interrupted with the aid of a closing valve 25. The outlet of the cleaning device 1 is connected to a vacuum pump 20.

If and when the casting piston 20 is moved to the right in the casting chamber 18. the casting piston 20 as from a specific position closes the filling opening 19. The right-side part of the casting chamber 18 (piston chamber) and the void 23 in the case of a closed valve 25 are now hermetically sealed in relation to the environment. Upon opening of the valve 25 and actuation of the pump 26, the gaseous atmosphere which is located in the piston chamber of the casting chamber 18 and in the void 23 is conjointly drawn with part of the casting material through the flow duct 24 into the cleaning device 1 where the medium is cleaned as has been previously described. The cleaned medium (here gas) exits the cleaning device 1 and makes its way to the vacuum pump 26. The vacuum die-casting method may now be performed as previously described.

FIG. 3 shows a schematic view of a further embodiment of the die-casting device according to the invention.

The die-casting device according to FIG. 3 largely corresponds to the die-casting device shown in FIG. 2. Same reference signs refer to same elements in FIGS. 2 and 3. However, in the case of the embodiment according to FIG. 3 the cleaning device 1 according to the invention is connected directly to the casting chamber 18 via a closing valve 27. The void 23 is connected to a standard filter element 28 via the closing valve 25 and the flow duct 24. The outlets of the cleaning device 1 and the standard filter element 28 are connected to the vacuum pump 26.

If and when the casting piston 20 is moved to the right in the casting chamber 18, the casting piston 20 as from a specific position closes the filling opening 19. The right-side part of the casting chamber 18 (piston chamber) and the void 23 in the case of closed valves 25 and 27 are now hermetically sealed in relation to the environment. Upon opening of the valve 27 and actuation of the pump 26, the gaseous atmosphere which is located in she piston chamber of the casting chamber 18 is conjointly drawn with part of the casting material into the cleaning device 1 where the medium is cleaned as has been previously described. The cleaned medium (here gas) exits the cleaning device 1 and makes its way to the vacuum pump 26. Upon additionally opening the valve 25, the gaseous atmosphere which has remained in the void 23 is drawn through the standard filter element 28 into the vacuum pump 26. The vacuum die-casting method may now be performed as previously described.

1-15. (canceled)

18. A cleaning device comprising:
a housing having an inlet for a medium to be cleaned,
a centrifugal separator which is disposed downstream of the inlet in the housing,
a unit which is disposed on the housing and protrudes into the centrifugal separator and has, at a lower end thereof, at least one opening,
wherein the medium to be cleaned enters into the unit through the at least one opening,
a filter insert is disposed in the unit, and
an outlet which is disposed downstream of the filter insert.

17. The cleaning device according to claim 16, wherein the filter insert is constructed from two plates in the unit, said plates are provided with openings, and from a filter medium which is disposed between the plates.

18. The cleaning device according to claim 16, wherein the housing has a closable opening which is at least partially separable from the housing for removing deposits.

19. The cleaning device according to claim 18, wherein the unit has a pipe which protrudes into the centrifugal separator.

20. The cleaning device according to claim 19, wherein the pipe outside the housing opens into a portion of the unit in which the filter insert is located and on which the outlet is disposed.

21. The cleaning device according to claim 20, wherein the portion of the unit has a closable opening.

22. The cleaning device according to claim 18, wherein a device for measuring a pressure loss, at the filter insert, is disposed on the unit.

23. The cleaning device according to claim 18, wherein devices for connection between the cleaning device and components of a plant are disposed at the inlet and at the outlet.

24. A device for manufacturing castings, comprising a cleaning device according to claim 18.

25. The device according to claim 24, wherein the inlet of the cleaning device is connected to an interior of a casting mold or to an interior of a casting chamber.

28. The device according to claim 24, wherein the outlet of the cleaning unit is connected to a pump.

27. A method of use of a cleaning device according to claim 18 in a device for manufacturing castings, the method comprising directing a gaseous atmosphere from a casting chamber of said device through a cleaning device.

28. A method for manufacturing castings with a device according to claim 24, the method comprising:
hermetically closing a void of a casting mold in relation to an environment,
at least partially removing a gaseous atmosphere from a casting chamber and from the void of the casting mold, and
filling casting material into the void of the casting mold,
wherein the gaseous atmosphere removed from the casting chamber and/or from the void is directed through the cleaning device.

29. The method according to claim 28, wherein closing the void of the casting mold, in relation to the environment, is performed by movement of a casting piston in the casting chamber in such a manner that a filling opening of the casting chamber is no longer fluidically connected with the void of the casting mold.

30. A method of use of a device according to claim 24, for manufacturing castings, comprising directing a gaseous atmosphere from a casting chamber of said device through the cleaning device.
